(19) United States
(12) Patent Application Publication
(10) Pub. No.: US 2013/0138454 A1
(43) Pub. Date: May 30, 2013

(54) EXTENDABLE DECISION SUPPORT SYSTEM

(71) Applicants: Cornelis Conradus Adrianus Maria Van Zon, Fishkill, NY (US); William Palmer Lord, Fishkill, NY (US)

(72) Inventors: Cornelis Conradus Adrianus Maria Van Zon, Fishkill, NY (US); William Palmer Lord, Fishkill, NY (US)

(73) Assignee: KONINKLIJKE PHILIPS ELECTRONICS N.V., EINDHOVEN (NL)

(21) Appl. No.: 13/814,509

(22) PCT Filed: Jul. 25, 2011
(86) PCT No.: PCT/IB11/53301

§ 371 Date: Feb. 6, 2013

Related U.S. Application Data
(60) Provisional application No. 61/375,131, filed on Aug. 19, 2010.

(51) Int. Cl. G06F 19/00

(52) U.S. Cl. CPC G06F 19/34
USPC 705/2

(57) ABSTRACT

A system (100) includes a processor (102) that executes a clinical decision support application (202). The system further includes a module store (112) that includes one or more decision support modules (206) for use by the CDS application. The application includes one or more interfaces (204) that provide at least one interface between the CDS application and the one or more decision support modules. The one or more interfaces includes an interface that supports one or more newly added specific decision support modules, and the system is extendable by adding the one or more specific decision support modules.

The following generally relates to clinical informatics and is described with particular application to clinical decision support systems and more particularly to an extendible clinical decision support system that can be extended through one or more modular decision support components.

A clinical decision support (CDS) system generally is a computing system that facilitates decision-making in the clinical setting by supporting health care providers with issues such as time critical procedure guidance, workflow management, information tracking, and quality assurance. By giving care providers reliable access to patient data when and where it is needed and, for example, promoting adherence to clinical guidelines, such systems can help reduce the number of preventable in-hospital deaths. Improving patient care can also reduce the average length of hospital stay for patients, and thereby bring down costs for hospitals, patients and insurers. Clinical guidelines have also become an important tool in determining medical reimbursements, for example, with Pay for Performance plans in which providers are reimbursed on the basis of established quality improvement targets.

A CDS system can be based on a client/server architecture. With this type of system, the clients provide the user interface and CDS functionality and the server is responsible for synchronizing all clients. Components of the system include an engine for executing computerized clinical guidelines otherwise known as computer interpretable guidelines (“CIGs”) and a forms engine. Clinical guidelines are a documented set of recommendations (based on the best available evidence) for healthcare professionals which suggest the appropriate treatment and care of people with specific diseases and conditions. To use clinical guidelines in a CDS application, they are first transformed into CIGs. Whereas clinical guidelines are declarative and generic, CIGs are procedural and specific (to a given patient, care provider, etc.).

This type of CDS system also includes a graphical component or viewer that provides a graphical depiction of the guideline, with each node in the graph representing a particular workflow step (i.e., an action or decision). It can be used to provide a color-coded overview of a patient's state of care. The state of the guideline is updated as a function of user interactions and external events such as new patient findings. Associated with each node is a form that provides access to clinical data elements relevant to the action or decision represented by the node. These contextual forms are provided by the forms engine, which also handles patient findings entered by the user.

As a guideline adherence/workflow management/information tracking/quality assurance system, the CDS system provides the following types of support: a “you are here” view on the state of care enables efficient patient hand-off among care providers; contextual (care step specific) data forms provide access to patient information when and where it is needed (“what you need to know now”); progress bars indicate how much time is left for critical care steps (“what you need to do by when”), and synchronized clients support efficient collaboration among care providers (“what you see is what I see”). However, the guideline-driven CDS system does not explicitly provide assistance with making the decisions associated with guideline nodes, which typically span a range from trivial to very complex, and from inconsequential to impacting patient survival.

Aspects of the present application address the above-referenced matters, and others.

According to one aspect, a system includes a processor that executes a clinical decision support (CDS) application. The system further includes a module store that includes zero or more decision support modules for use by the CDS application. The system further includes one or more software interfaces that provide at least one interface between the CDS application and the zero or more decision support modules. The one or more interfaces includes an interface that supports one or more newly added specific decision support modules, and the system is extendable by adding the one or more specific decision support modules.

According to another aspect, a computer readable storage medium encoded with instructions which, when executed by a processor of a computer, cause the processor to: install and activate a new decision support module for a computer executable clinical decision support application using one or more interfaces at at least one of design time, configuration time or run time.

According to another aspect, a method includes receiving a request, during run time, to install a new decision support module for a clinical decision support application. The method further includes detecting the clinical decision support application is executing. The method further includes installing the decision support modules utilizing an interface that supports newly added decision support modules. The method further includes configuring the clinical decision support application to employ the newly added decision support module.

According to another aspect, a method includes installing a decision support module for a clinical decision support application utilizing an interface that supports newly added decision support modules. The method further includes restarting the clinical decision support application to employ the newly added decision support module. The method further includes detecting the newly added decision support module.

According to another aspect, a method includes adding an interface, at design time, that supports adding newly added decision support modules to a clinical decision support application. The method further includes adding a newly added decision support module, at design time, to the clinical decision support application, using the interface.

The invention may take form in various components and arrangements of components, and in various steps and arrangements of steps. The drawings are only for purposes of illustrating the preferred embodiments and are not to be construed as limiting the invention.

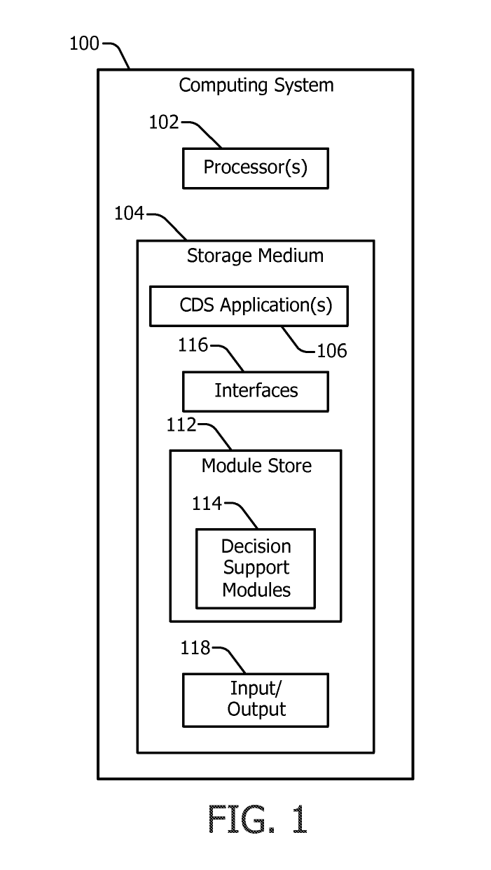

FIG. 1 illustrates an example computing system that executes a clinical decision support (CDS) application configured to receive pluggable decision support modules.

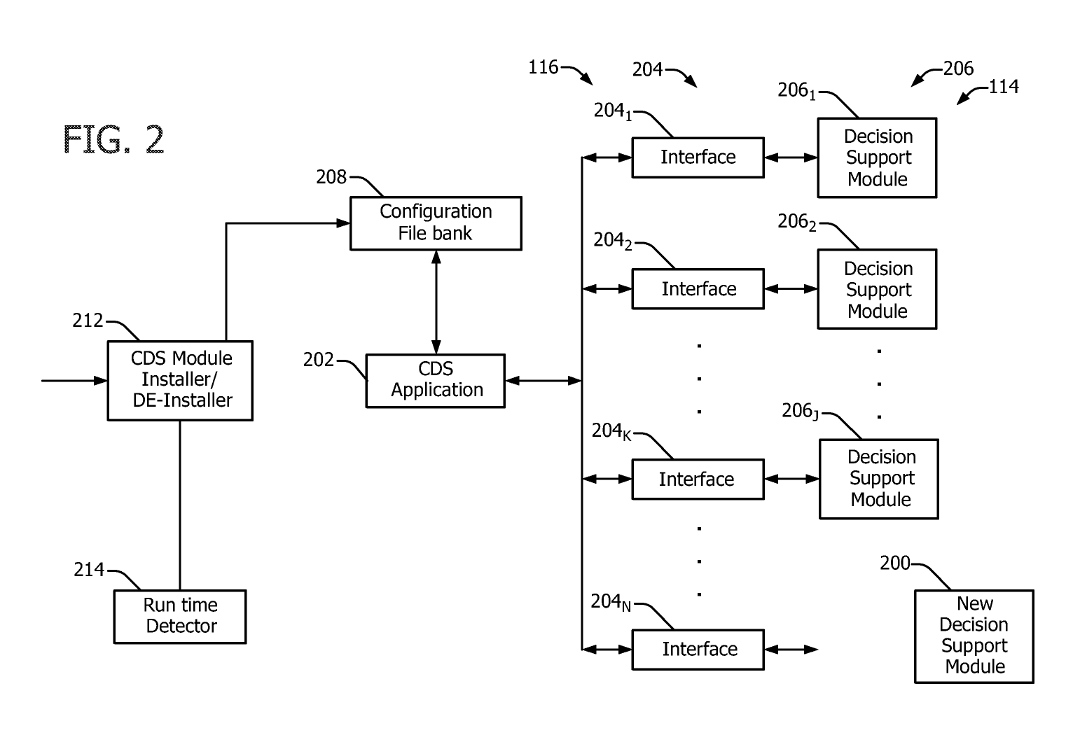

FIG. 2 illustrates an example CDS application in connection with decision support modules, interfaces between the CDS application and the decision support modules, and other components employed by and/or in connection with the CDS application.

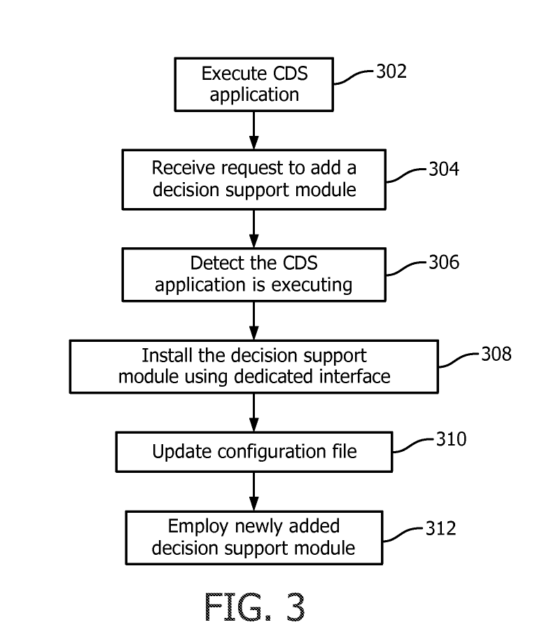

FIG. 3 illustrates a method for run time additions of decision and/or action specific decision support modules.

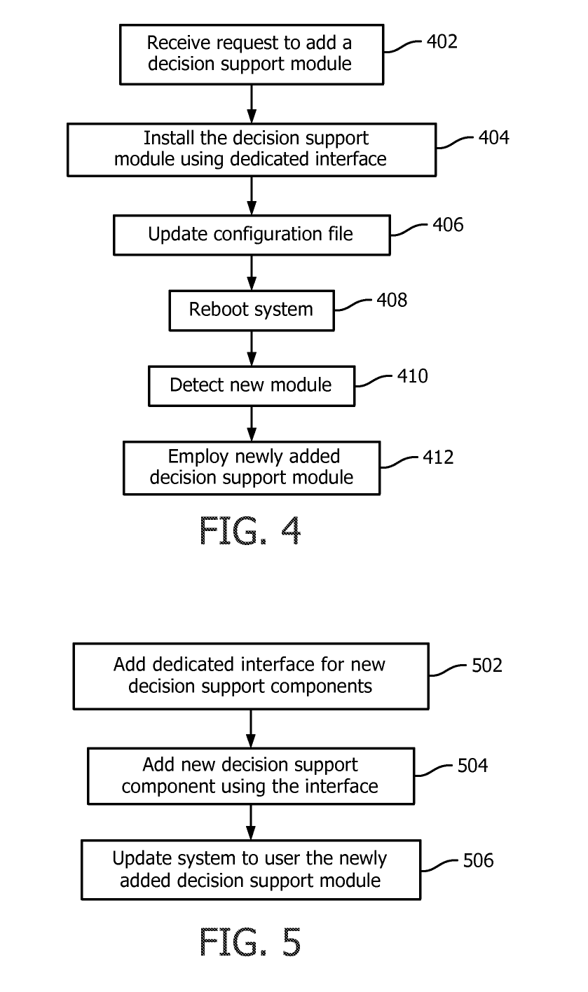

FIG. 4 illustrates a method for configuration time additions of decision and/or action specific decision support modules.

FIG. 5 illustrates a method for design time additions of decision and/or action specific decision support modules.

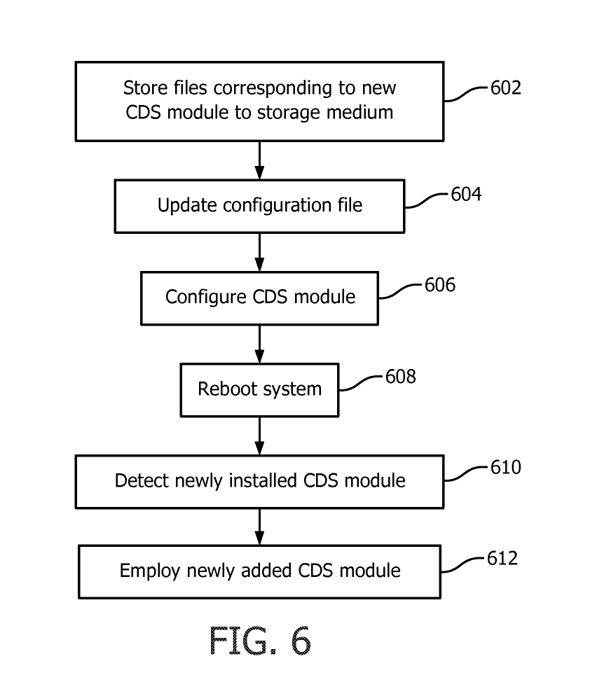

FIG. 6 illustrates a method for adding a new clinical decision support (CDS) module for use by a CDS application.

FIG. 1 illustrates a computing system 100 such as a workstation, a desktop computer, or the like. The computing system 100 may be a standalone computing system or part of a network distributed across multiple healthcare provision sites.

The computing system 100 includes one or more processors 102 and computer readable storage medium 104 encoded with computer readable instructions, which, when executed by the one or more processors 102 cause the system 100 to execute at least a clinical decision support (CDS) application (such as a guideline driven or based CDS application, which can execute clinical guidelines), decision support modules for the CDS application, and interfaces between the CDS application and the decision support modules.

The illustrated system 100 is configured to execute computer interpretable guidelines (CIGs) one at a time and alternatively concurrently. Suitable guidelines may be directed towards, but are not limited to, trauma, myocardial infarction, coronary heart failure, chest pain, asthma, atrial fibrillation, burns, diabetes, drug overdose, earache, gastrointestinal, and/or other clinical guidelines. Guidelines may be specific to a single subject and/or apply to a group of subjects. Hereafter, ‘guideline’ refers to computer interpretable guideline.

An example of a system that focuses on executing one guideline at a time is described in PCT/IB2009/054775, filed on Nov. 6, 2008, and entitled “Executable Clinical Guideline and Guideline Tool,” which is incorporated herein by reference in its entirety. An example of a system that can concurrently execute multiple guidelines is described in PCT/IB2009/054779, filed on Nov. 6, 2008, and entitled “Method and System for Simultaneous Guideline Execution,” which is incorporated herein by reference in its entirety.

A module store 112 includes one or more decision support modules 108. This includes decision and/or action specific decision support modules. Interfaces 116 provide interfaces between an executing CDS application of the CDS applications 106 and the one or more decision support modules 108. Input/output 118 allows for presenting various information such as clinical decision suggestion, a guideline, a workflow, etc., via a display, monitor, or the like and/or accepting user input via a keyboard, a mouser, or the like in connection with an executing CDS application.

As described in greater detail below, the system 100 is scalable and configured such that one or more new decision support modules can be added and/or removed at design time, configuration time, and/or run time. This allows one (e.g., a programmer at design time and a system administrator at configuration and/or run-time) to add one or more decision and/or action specific decision support modules, for example, to support more complex, higher prone to error and/or higher-risk decisions, if desired or required.

FIG. 2 illustrates an exemplary CDS application 202 that has been executed and is running or executing in connection with the interface(s) 116 and the decision support modules 114.

The interface(s) 116 include N interfaces 204 (where N is an integer equal to or greater than one and represents a number of interfaces), including interface 204₁, 204₂, . . . , 204_{K}, . . . , 204_{N}. The decision support modules 114 include J decision support modules 206 (where J is an integer equal to or greater than zero and represents a number of interfaces), including decision support modules 206₁, 206₂, . . . , 206_{J}.

In the illustrated embodiment, each of the J decision support modules 206 interfaces with a corresponding one of the N interfaces 204. An interface 204_{N} may be dedicated to support at least a new (or newly added) decision support module 200.

It is alternatively possible for the interface(s) 116 to comprise only a single interface that can interface with the J decision support modules 206 and/or other decision support modules such as the new decision support module 200. Or it is alternatively possible for one or more of the interfaces of interface(s) 116 to interface with one or more the decision support modules 206.

A configuration file bank 208 stores the configuration files used by the CDS application 202.

A clinical decision support (CDS) application module installer/de-installer 212 install and de-installs decision support modules. This includes updating the configuration files in the configuration file bank 208 to support newly added decision support modules 206. The CDS application module installer/de-installer 212 may also be used to remove configuration and/or code for de-installed decision support modules. The installer/de-installer 212 can be part of the CDS application.

A run time detector 214 detects whether the CDS application is being executed or not. Such information is used by the CDS application module installer/de-installer 212 to facilitate installing and activating new decision support module 200. For example, this information may be used to determine whether the system 100 should be rebooted or not after the installation of a decision support module and any updates, for example, to the configuration file bank 208. The run time detector 214 can be part of the CDS application.

FIG. 3 illustrates a method for adding one or more decision support modules to the system 100 at run time. Generally, run time refers to a state in which the CDS application is in use, i.e., it is executing on the system 100. With this example, the decision support modules are plug and play modules.

It is to be appreciated that the ordering of the following acts is not limiting. As such, in other examples, the ordering may be different. Furthermore, in other examples, additional acts may be added and/or one or more of the acts may be omitted.

At 302, a CDS application is executed (i.e., up and running). As described herein, this may include the system 100 employing the one or more processors 102 to execute the CDS application instructions in the storage medium 104.

At 304, the CDS module installer/de-installer 212 receives a request to install one or more decision support modules 206.

At 306, the run time detector 214 detects that request has been received during run time.

At 308, the CDS module installer/de-installer 212 installs the one or more decision support modules 206 utilizing interfaces that support newly added decision support modules.

At 310, the CDS module installer/de-installer 212 updates the configuration file bank 208 with new configuration data for the CDS application and for the newly installed one or more decision support modules 206.

At 312, the CDS application employs one or more of the newly installed decision support modules 206.

FIG. 4 illustrates a method for adding one or more decision support modules to the system 100 at configuration time. Generally, configuration time refers to a state before or between execution of the CDS application 100.

It is to be appreciated that the ordering of the following acts is not limiting. As such, in other examples, the ordering may be different. Furthermore, in other examples, additional acts may be added and/or one or more of the acts may be omitted.

At 402, the CDS module installer/de-installer 212 receives a request to install one or more decision support modules 206. In another instance, this act is omitted.

At 404, the CDS module installer/de-installer 212 installs the one or more decision support modules 206 utilizing interfaces that support newly added decision support modules.

At 406, the CDS module installer/de-installer 212 updates the configuration file bank 208 with one or more configuration files for the newly installed one or more decision support modules 206. Alternatively, one or more existing configuration files are updated with settings for the newly installed modules 206. The one or more configuration files may additionally or alternatively reside in a database, registry, etc.

At 408, the system 100 is rebooted.

At 410, an executing CDS application detects the newly installed one or more decision support modules 206.

At 412, the executing CDS application employs the newly installed one or more decision support modules 206.

FIG. 5 illustrates a method for adding one or more decision support modules to the system 100 at design time.

It is to be appreciated that the ordering of the following acts is not limiting. As such, in other examples, the ordering may be different. Furthermore, in other example, additional acts may be added and/or one or more of the acts may be omitted.

At 502, one or more interfaces for adding decision support modules for use by a CDS application is provided. In another example, this act is omitted, for example, in instances in which the new modules can connect via an existing interface.

At 504, one or more decision support modules are added to the system.

At 506, the CDS application is updated to use the added one or more decision support modules.

FIG. 6 illustrates a method for adding a new clinical decision support (CDS) module for use by an executing CDS application.

It is to be appreciated that the ordering of the following acts is not limiting. As such, in other examples, the ordering may be different. Furthermore, in other examples, additional acts may be added and/or one or more of the acts may be omitted.

At 602, one or more files corresponding to a new CDS module are stored on storage medium 104.

At 604, a configuration file utilized by a CDS application of the system 100 is updated to inform the CDS application of the new CDS module.

At 606, optionally, the configuration file is updated to configure the CDS module.

At 608, the system 100 is rebooted.

At 610, the CDS application is executed by the system 100 and detects the newly installed CDS module.

At 612, the executing CDS application employs the newly installed CDS module.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A system, comprising:
a processor that executes a clinical decision support. (CDS) application (202);
a module store that includes zero or more decision support modules for use by the CDS application; and
one or more interfaces that provide at least one interface between the CDS application and the one or more decision support modules,
wherein the one or more interfaces include an interface that supports one or more newly added specific decision support modules, and the system is extendable by adding the one or more specific decision support. modules.

2. The system of claim. 1, further comprising:
a configuration file bank for storing configuration files for the CDS application and/or the decision support modules, wherein the processor updates the configuration file bank with configuration files corresponding to the one or more newly added specific decision support modules.

3. The system of claim 1, wherein a specific decision. support module is added at design time utilizing an existing interface of the CDS application.

4. The system of claim 1, wherein a specific decision support module is added at design. time along with a corresponding interface.

5. The system of claim 1, wherein a specific decision support module is added at configuration time.

6. The system of claim 5, wherein the processor reboots the system to activate the one or more newly added specific decision support modules and the updated configuration files for use by a CDS application.

7. The system of claim 1, wherein a specific decision support module is added at run time.

8. The system of claim 7, wherein the processor configures the CDS application during run time to employ the one or more newly added specific decision support modules and the updated configuration files in response to detecting the CDS application is executing.

9. The system of claim wherein the one or more newly added specific decision support modules provide support for at least one of complex, prone to error, or higher-risk decisions.

10. A computer readable storage medium encoded with computer executable instructions, which, when executed by a processor of a computer, cause the processor to
install and activate a new decision support module for a computer executable clinical decision support application using one or more interfaces at at least one of design. time, configuration. time or run time

11. A method, comprising:
receiving a request, during run time, to install a new decision support module for a clinical decision support application;
installing the decision support modules utilizing an interface that supports a newly added decision support modules; and
configuring the clinical decision support application to employ the newly added decision support module.

12. The method of claim 11, further comprising:
updating a configuration file bank with one or more configuration files for the newly installed decision support module.

13. The method of claim 12, further comprising:
configuring the clinical decision support application to employ the updated configuration file bank.

14. A method, comprising:
installing a new decision support module for a clinical decision. support application utilizing an interface that supports newly added. decision support modules;
rebooting the clinical decision support system to employ the newly added decision support module; and
detecting the newly added decision support module.

15. The method of claim 14, further comprising:
receiving a request, at configuration time, to install the new decision support. module during configuration time;

16. The method of claim 14, further comprising:
employing the newly added decision support module with a clinical decision support application.

17. The method of claim. 16, further comprising:
updating a configuration file bank with. one or more configuration files for the newly installed decision support module.

18. A method, comprising:
adding an interface, at design time, that supports adding newly added decision support modules to a clinical decision support application; and
adding a newly added. decision support module, at design. time, to the clinical decision support application, using the interface.

19. The method of claim 18, where the interface is an existing interface of the decision support application.

20. The method of claim 18, further comprising:
employing the newly added decision support module with a clinical decision support application.
